(19) United States
(12) Patent Application Publication
(10) Pub. No.: US 2010/0032185 A1
(43) Pub. Date: Feb. 11, 2010

(54) Method for Water-Sealing Treatment of On-Vehicle Electric Cables

(75) Inventors: Daisuke Hashimoto, Yokkaichi-shi (JP); Toshio Kometani, Yokkaichi-shi (JP); Kenji Miyamoto, Yokkaichi-shi (JP); Hirotaka Yamada, Nagoya-shi Aichi (JP)

Correspondence Address: OLIFF & BERRIDGE, PLC, P.O. BOX 320850, ALEXANDRIA, VA, 22320-4850, US

(73) Assignees: AUTONETWORKS TECHNOLOGIES, LTD., MIE (JP); SUMITOMO WIRING SYSTEMS, LTD., MIE (JP); SUMITOMO ELECTRIC INDUSTRIES, LTD., OSAKA (JP)

(21) Appl. No.: 12/084,292

(22) PCT Filed: Nov. 1, 2006
(86) PCT No.: PCT/JP2006/321838

§ 371 Date: Feb. 23, 2009

(30) Foreign Application Priority Data
Nov. 2, 2005 (JP) 2005-319108

(51) Int. Cl. H01B 7/282; F16L 5/02

(52) U.S. Cl. 174/120 R; 277/314

(57) ABSTRACT

The present invention is intended to enable a efficient water-sealing treatment for an on-vehicle electric cable 10, i.e., an electric cable to be mounted on a vehicle, the cable having a conductor and a sheath disposed on the outside of the conductor, regardless of a length of the electric cable. The present invention provides a method comprising the step of establishing a state where a water-sealing agent 18 with fluidity covers a gap between the conductor and the sheath in an end of the on-vehicle electric cable 10, for example, through an operation of dropping the water-sealing agent 18 onto the end of the on-vehicle electric cable 10, and the step of pressurizing an ambient air around the water-sealing agent 18 to cause the water-sealing agent 18 to penetrate into the inside of the sheath of the on-vehicle electric cable 10.

### TECHNICAL FIELD

The present invention relates to a technique for subjecting an on-vehicle electric cable, i.e., an electric cable to be mounted to a vehicle, to a water-sealing treatment.

### BACKGROUND ART

Some electric cables require a high waterproof capability when they are used as on-vehicle electric cables. For example, such on-vehicle electric cables include a grounding cable for grounding an electric circuit to be provided in a vehicle or the like. In this case, a grounding terminal is fixed to an end of the grounding cable, and connected to an appropriate grounded region (e.g., a vehicle body) in an externally exposed state. Thus, water is likely to get into the grounding cable, and intrude into the circuit through the inside of a sheath of the grounding cable to cause a risk of hindering a normal operation of the circuit.

There is disclosed one method for the water-sealing treatment of an on-vehicle electric cable including the grounding cable in the following Patent Publication 1. In this method, a water-sealing agent having fluidity is supplied to a first one of opposite ends of an on-vehicle electric cable, and sucked from the other, second, end of the on-vehicle electric cable, thus being drawn into a gap between the sheath and an inner wire segment of the on-vehicle electric cable to fill the gap.

The method described in the Patent Publication 1 requires the supply of the water-sealing agent to the first end of the on-vehicle electric cable, and a placement of the second end into a depressurization container or the like. That is, it is necessary to perform separate operations for the respective ends of the on-vehicle electric cable. This complicates an operation management of the on-vehicle electric cable. Particularly in a treatment of an electric cable with a large overall length, it becomes more difficult to handle the electric cable itself, and the handling requires a large space.

Moreover, this method requires an operation of sucking an air residing in the inside of the on-vehicle electric cable from the second end to draw the water-sealing agent supplied to the first end, into the electric cable. This suction is likely to involve a pressure loss, which becomes larger along with an increase in length of the on-vehicle electric cable.

Patent Publication 1: JP 2004-355851A

### DISCLOSURE OF THE INVENTION

In view of the above circumstances, it is an object of the present invention to provide a technique for efficiently performing a water-sealing treatment of an on-vehicle electric cable regardless of a length of the electric cable.

As means for achieving this object, the present invention provides a method for the water-sealing treatment of an on-vehicle electric cable which has an inner wire segment and a sheath covering the inner wire segment. The method comprises: a water-sealing-agent placing step of establishing a state in which a water-sealing agent having fluidity covers a gap between the inner wire segment and the sheath of the on-vehicle electric cable, from the outside of the sheath; and a pressurizing step of setting a pressure of an ambient air around the water-sealing agent covering the gap higher than a pressure of the inside of the sheath, to cause the water-sealing agent to penetrate into the inside of the sheath.

In this method, the water-sealing treatment can be performed by subjecting the same region of the on-vehicle electric cable to both the water-sealing-agent placing step of establishing the state in which the water-sealing agent covers the gap between the inner wire segment and the sheath in one of opposite ends of the on-vehicle electric cable, and the pressurizing step of setting a pressure of an ambient air around the placed water-sealing agent higher than a pressure of the inside of the sheath to cause the water-sealing agent to penetrate into the inside of the sheath. Thus, any operation is not specifically required for the remaining region; for example, the remaining region may be left under an atmospheric pressure. This facilitates a management for positioning of a target region in the electric cable, as compared with the conventional method designed to place a water-sealing agent onto a first one of opposite ends of an electric cable and sucking an air residing in the inside of a sheath from the other, second, end, thereby enhancing operating efficiency. In addition, the method of the present invention involves almost no risk of occurrence of a pressure loss which would otherwise occur in the method designed to depressurize the inside of the sheath. This enables an efficient water-sealing treatment regardless of a length of the cable.

The present invention are not specifically limited to a type and a region of the on-vehicle electric cable to be subjected to the treatment. In cases where the inner wire segment includes a plurality of wires, the function of “causing the water-sealing agent to penetrate into the inside of the sheath” includes not only a function of “causing the water-sealing agent to penetrate into the gap between the inner wire segment and the sheath” but also a function of “causing the water-sealing agent penetrate into gaps between the respective wires constituting the inner wire segment”. This enables a more effective water-sealing treatment.

The present invention is particularly effective in a water-sealing treatment of an electric cable having an end which is likely to be exposed to rain water or the like, such as a grounding cable being designed to connect to ground a circuit to be mounted on a vehicle, and having at least one of opposite ends to which a grounding terminal adapted to be connected to a specific region of the vehicle is attached. In the water-sealing treatment of the grounding cable, the water-sealing-agent placing step and the pressurizing step may be performed on at least the end for attachment of the grounding terminal.

Except the grounding cable, the present invention, can be also applied to an on-vehicle electric cable, for example, of a type having a relatively high possibility of occurrence of intrusion of water into the inside of a sheath thereof, such as a spliced cable having a sheath peeled in an intermediate region thereof, or a type adapted to be connected to a circuit requiring a particularly high waterproof capability in itself even though a connecter has a waterproof function. The present invention is also effective in a water-sealing treatment of these types of electric cables. Furthermore, the present invention can be applied to an on-vehicle electric cable including a covered wire serving as the inner wire segment, and a sheath covering the covered wire from outside.

In the present invention, a specific value of the pressure to be applied during the pressurizing step may be appropriately set. Generally, setting the pressure higher can reduce a time required for the water-sealing treatment. However, the conventional method, designed to draw a water-sealing agent into an electric cable while performing the depressurizing operation in the second end, practically cannot allow a difference between an exterior pressure (atmospheric pressure) around the water-sealing agent and a pressure of the inside of the sheath to be at 1 atm or more. Differently, in the present invention, setting an absolute pressure of the ambient air around the water-sealing agent up to two times or more of an atmospheric pressure during the pressurizing step allows the difference between respective pressures of an ambient air around the water-sealing agent and an air residing in the inside of the sheath to be 1 atmospheric pressure or more. This can further reduce the time required for the water-sealing treatment.

In the present invention, for example, an electric cable terminal may be attached to one of opposite ends of the on-vehicle electric cable, which end has been subjected to the water-sealing-agent placing step and the pressurizing step. However, the present invention is particularly effective in a situation where a step of locally removing the sheath of the on-vehicle electric cable to expose the inner wire segment is performed in advance of the water-sealing-agent placing step and the pressurizing step. In this case, a boundary portion between a region which has undergone the sheath removal and the remaining region excluded from the sheath removal may be subjected to the water-sealing-agent placing step and the pressurizing step.

For example, in the method including a terminal attaching step of removing the sheath in one of opposite ends of the on-vehicle electric cable and attaching an electric cable terminal to the end, the terminal attaching step is preferably followed by the water-sealing-agent placing step and the pressurizing step performed on the end having the electric cable terminal attached thereto. In this case, differently from a process of subjecting one of opposite ends of the on-vehicle electric cable to the water-sealing-agent placing step and the pressurizing step and then attaching the electric cable terminal to the end, the operation of attaching the electric cable terminal does not influence the water-sealing agent filled in the cable by the water-sealing-agent placing step and the pressurizing step, and the on-vehicle electric cable can be provided as a product while maintaining the water-sealing agent in a filling state just after completion of the water-sealing treatment.

In this case, the water-sealing-agent placing step preferably includes dropping the water-sealing agent onto the end of the on-vehicle electric cable having the electric cable terminal attached thereto, in such a manner that the water-sealing agent covers a gap between the inner wire segment and the sheath in the end, from the outside of the sheath.

Further, the pressurizing step preferably includes supplying a compressed air into a pressurization container containing the end of the on-vehicle electric cable having the electric cable terminal attached thereto, together with the electric cable terminal. This step makes it possible to pressurize an ambient air around the water-sealing agent by a simple operation of supplying a compressed air into the pressurization container containing the end of the on-vehicle electric cable having the electric cable terminal attached thereto.

The sheath removing step may include locally removing the sheath in an intermediate region of the on-vehicle electric cable in order to form a spliced portion (branching connection portion) or the like. In this case, each of opposite ends in the region which has undergone the sheath removal may be subjected to the water-sealing-agent placing step and the pressurizing step.

As above, in the present invention, performing both the water-sealing-agent placing step and the pressurizing step on one of opposite ends of the on-vehicle electric cable allows, the water-sealing agent to fill the end. This makes it possible to efficiently perform a water-sealing treatment of the on-vehicle electric cable regardless of a length of the cable and thereby obtain an on-vehicle electric cable having high water-sealing performance.

### BRIEF DESCRIPTION OF DRAWINGS

FIG. 1(a) is a top plan view showing a structure of a combination of a grounding cable according to a first embodiment of the present invention and a grounding terminal crimpedly fixed to one of opposite ends of the grounding cable.

FIG. 1(b) is a front view of the structure in FIG. 1(a).

FIG. 2 is a schematic diagram showing one example of an apparatus for pressurizing an ambient air around an end of the grounding cable having a water-sealing agent placed thereon.

FIG. 3 is a perspective view schematically showing a spliced portion of an on-vehicle electric cable according to a second embodiment of the present invention, wherein the spliced portion is to be subjected to a water-sealing treatment.

FIG. 4 is a perspective view showing an end of an on-vehicle electric cable according to a second embodiment of the present invention, wherein the end is to be subjected to a water-sealing treatment.

FIG. 5 is a graph showing a relationship between a treatment time and a penetration distance in a water-sealing treatment performed using the apparatus illustrated in FIG. 2.

### BEST MODE FOR CARRYING OUT THE INVENTION

With reference to the drawings, a preferred embodiment of the present invention will be described. In the following embodiment, a water-sealing treatment is provided to a grounding cable for connecting a circuit mounted on a vehicle to ground. As mentioned above, the present invention can however be applied to various types of on-vehicle electric cables requiring a high waterproof capability, not limited to the grounding cable.

A method for the water-sealing treatment of the grounding cable according to this embodiment includes the following steps.

1) Terminal Attaching Step

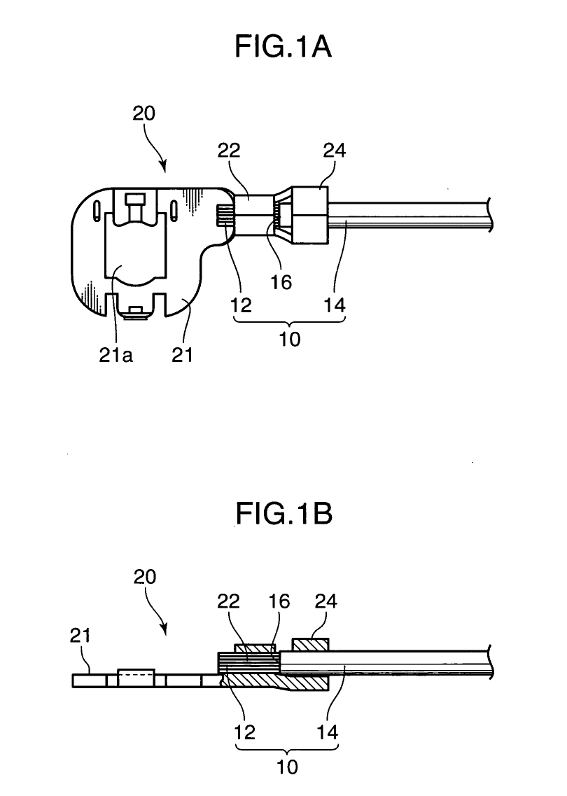

This step is a step of attaching a grounding terminal 20 to one end 16 of opposite ends of a grounding cable 10 as shown in FIGS. 1(a) and 1(b).

In the illustrated embodiment, the grounding cable 10 comprises an inner conductor 12, and a sheath 14 disposed around the inner conductor 12, wherein the sheath 14 is made of an electrical insulating material. An operation of removing the sheath 14 in one end 16 of opposite ends of the grounding cable 10 by a given length is performed to expose the inner conductor 12 (the end 16 will hereinafter be referred to as “target end 16”).

Onto the target end 16, a grounding terminal 20 as shown in FIGS. 1(a) and 1(b) is crimpedly fixed. The grounding terminal 20 in the illustrated embodiment is formed by bending a single metal plate, integrally having a ground connection portion 21 to be connected to a body of a vehicle, a conductor barrel 22 and an insulation barrel 24, wherein the conductor barrel 22 and the insulation barrel 24 are located on a rearward side of the ground connection portion 21. The ground connection portion 21 has a bolt insertion hole 21a into which a bolt (not shown) can be inserted to fasten the ground connection portion 21 to an appropriate grounded region (typically an appropriate position of the body) of the vehicle. The fastening allows the inner conductor 12 of the grounding cable 10 to be connected to the grounded region of the vehicle through the grounding terminal 20.

In order to crimp the grounding terminal 20 onto the target end 16, the end of the grounding cable 10 which has undergone the removal of the sheath 14 in the above manner, i.e., the target end 16, is firstly placed between the barrels 22 and between the barrels 24 of the grounding terminal 20, each barrel being set in an open position. After completion of the placement, performed is an operation of bending each of the conductor barrel 22 and the insulation barrel 24 toward a closed position to crimpedly fix the conductor barrel 22 and the insulation barrel 24 onto the inner conductor 12 and the sheath 14 respectively.

2) Water-Sealing-Agent Placing Step

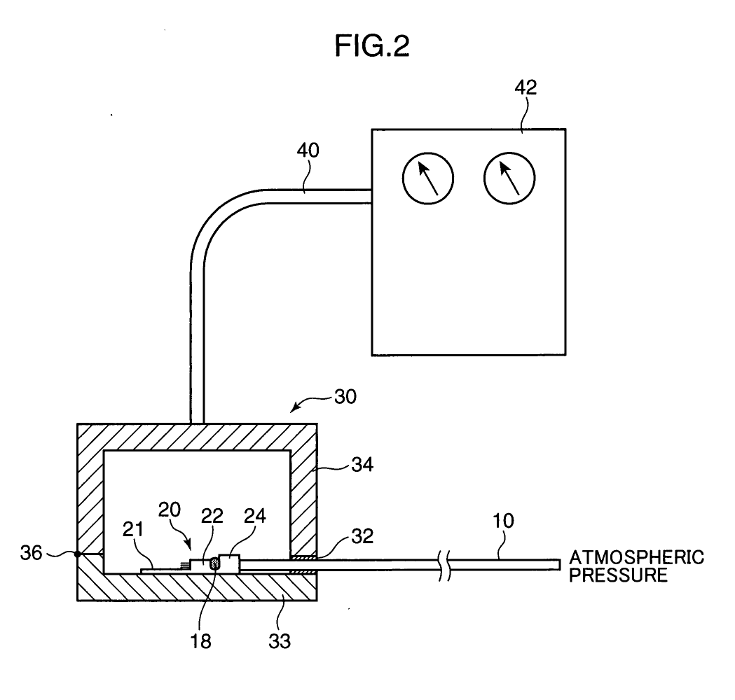

This step is a step of placing a water-sealing agent 18 as shown in FIG. 2 onto the target end 16 of the grounding cable 10 having the grounding terminal 20 attached thereto. Specifically, the water-sealing agent 18 is dropped from a dispenser (not shown) onto a region between the conductor barrel 22 and the insulation barrel 24 of the grounding terminal 20, and accumulated on the region, so as to cover a gap between the inner conductor 12 and the sheath 14 in the target end 16, from the outside of the sheath 14.

The water-sealing agent 18 may be dropped on a single cycle, or on a plurality of divided cycles. Upon start of the after-mentioned pressurizing step, penetration of the initially supplied water-sealing agent 18 into the inside of the sheath 14 reduces an amount of the water-sealing agent 18 accumulated on the grounding terminal 20; however, additionally dropping the water-sealing agent 18 in parallel with the pressurization step achieves supplement of the water-sealing agent 18 during the pressurization step. The supplement of the water-sealing agent 18 makes it possible to fill the gap between the inner conductor 12 and the sheath 14 with a sufficient amount of the water-sealing agent 18 evenly and reliably while maintaining the amount of the water-sealing agent 18 accumulated on the grounding terminal 20 at an approximately constant value.

Used as the water-sealing agent 18 is a type with fluidity in its initial state. This fluidity is required only at a level for allowing the water-sealing agent 18 to penetrate into the inside of the sheath 14, based on a difference between respective pressures of an ambient air around the water-sealing agent 18 and the inside of the sheath 14. It has been verified that the water-sealing agent 18 having a viscosity of 0.006 to 6 Pa·s in the initial state can generally penetrate into the inside of the sheath 14 during the after-mentioned pressurizing step.

The water-sealing agent 18 preferably has a property where its viscosity increases (i.e., it becomes cured) after the penetration enough to stably maintain its configuration of the water-sealing agent 18. This curing may be achieved in an uncontrolled or natural manner, or may be accelerated by ultraviolet light irradiation or heating. In either case, it is preferable that the water-sealing agent 18 will keep a certain level of resiliency even after the curing. This makes it possible to avoid occurrence of cracks and breakage in the water-sealing agent 10 due to an external force applied to the target end 16 during a wiring operation.

Specifically, the water-sealing agent 18 is preferably made of a silicone resin having a natural curing property or a light curing property, for example. An ultraviolet curing-type silicone resin typically comprises a primary component consisting of a polyfunctional silicone oligomer, and a photo-polymerization initiator (e.g., benzophenone-based, benzoin-based or acetophenone-based compound) contained in the primary component; the photo-polymerization initiator can be excited by expose to irradiation of ultraviolet light to generate a radical for inducing polymerization of the polyfunctional silicone oligomer. In order to impart the natural curing property to the silicone resin, a curing catalyst capable of accelerating a curing reaction under a presence of a moisture in air may be additionally contained in the silicone oligomer, for example.

Another material of the water-sealing agent 18 may include a polyfunctional monomer or oligomer, such as epoxy resin, polyurethane, polyester or an acrylate of butadiene.

3) Pressurizing Step

This step is a step of pressurizing an ambient air around the water-sealing agent 18 placed on the target end 16 of the grounding cable 10 up to at a value higher than that of a pressure of the inside of the sheath 14 (typically, atmospheric pressure), so as to forcibly cause the water-sealing agent 18 to penetrate into the inside of the sheath 14 based on the pressure difference.

This pressurization step can be performed by hermetically containing one of opposite ends of the grounding cable 10 which end has the grounding terminal 20 (i.e., the target end having the water-sealing agent 18 placed thereon) in a pressurization container 30 as shown in FIG. 2, and supplying a compressed air from a compressor 42 into the pressurization container 30 through a pipe 40.

The pressurization container 30 preferably has a seal member (e.g., rubber plug) 32 capable of coming into close contact with a specific region of the on-vehicle electric wire 10 over an entire circumference thereof, as shown in FIG. 2. The pressurization container 30 illustrated in FIG. 2 is divided into a lower base portion 33 and an upper cover portion 34 each including the seal member 32. The cover portion 34 is adapted to be rotatable about a hinge portion 36 in opening and closing directions. This opening/closing function facilitates an operation of placing the target end 16 inside the pressurization container 30. Specifically, the cover portion 34 is opened to allow the target end 16 to be placed on the base portion 33. Thereafter, the cover portion 34 is closed to allow the seal member 32 to come into close contract with the specific region of the cable 10 over the entire circumference thereof, thus hermetically sealing an internal space of the pressurization container 30.

The timing of placing the target end inside the pressurization container 30 may be before the water-sealing-agent placing step or after. Specifically, the target end 16 which has been subjected to the water-sealing-agent placing step may be placed inside the pressurization container 30; or alternatively, the water-sealing-agent placing step may be performed after the target end 16 is placed inside the pressurization container 30 and in advance of the pressurizing step.

The compressor 42 is preferably capable of adjusting a pressure of the compressed air. An internal pressure of the pressure chamber 30 may be set at an appropriate value. The present invention involves an advantage of having a wider settable range of the pressure difference serving as a moving force of the water-sealing agent 18, as compared with the conventional method designed to generate the pressure difference based on the depressurizing operation.

The conventional method, where the second end on the opposite side of the first end having the water-sealing agent 18 placed thereon is put in the depressurization container to perform the depressurizing operation, practically cannot allow a difference between a pressure after the depressurization (i.e., a pressure in the inside of the sheath 14) and a pressure of an ambient air around the water-sealing agent (i.e., atmospheric pressure) to be 1 atm or more, even if a perfect vacuum state is formed in an inner space of the pressurization container. On the other hand, in the above pressurizing step, the difference between an internal pressure of the pressurization container and a pressure (atmospheric pressure) of an air residing in the inside of the sheath 14 can be 1 atm or more when the internal pressure (absolute pressure) of the pressurization container 30 is set up higher than the atmospheric pressure by 1 atm or more.

It should be noted that the present invention does not exclude a pressurizing step under the pressure difference less than 1 atm.

The aforementioned pressurizing step can cause the water-sealing agent 18 placed in the water-sealing-agent placing step to penetrate into the inside of the sheath 14. When the inner conductor 12 comprises a plurality of wires for example, the function of “causing the water-sealing agent 18 to penetrate into the inside of the sheath 14” includes not only a function of causing the water-sealing agent 18 to penetrate into the gap between the inner conductor 12 and the sheath 14 but also a function of causing the water-sealing agent 18 to penetrate into gaps between the respective wires constituting the inner conductor 12. The penetration of the water-sealing agent into the gaps between the respective wires ensures the water-sealing capability more effectively.

In addition, the pressurizing step should be performed only on the common end of the cable to be subjected to the water-sealing-agent placing step, i.e., the target end 16, while the other end of the cable may be left, for example, under an atmospheric pressure. This facilitates an operation management and enables an efficient water-sealing treatment regardless of a length of the cable. Furthermore, differently from the conventional method designed to suck air from the second end, the pressurizing step involves almost no pressure loss in the cable regardless of the cable length.

The water-sealing-agent placing step and the pressurizing step may be performed, as mentioned above, after the terminal attaching step including the sheath removing step, or before the terminal attaching step. For example, the water-sealing-agent placing step may comprise immersing the target end into a water-sealing agent solution reserved in a container, and the pressurizing step may comprise pressurizing air above the water-sealing agent solution while maintaining the target end in the immersed state.

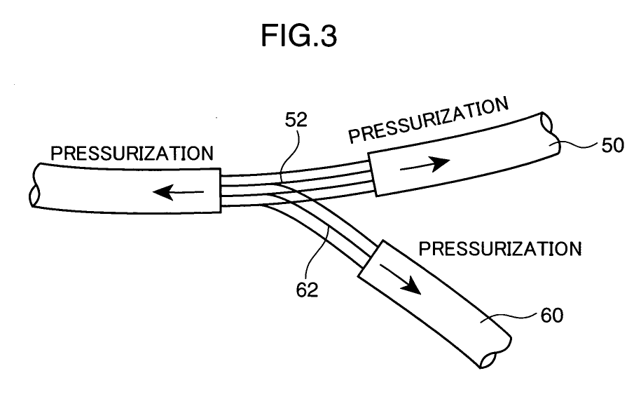

Even in the embodiment where the sheath removing step is performed in advance of the water-sealing-agent placing step and the pressurizing step, a position of the sheath to be removed in the sheath removal step is not limited to an end of the cable. FIG. 3 shows a second embodiment where the present invention is applied to a spliced portion, i.e., a branching connection portion, of an on-vehicle electric cable.

In the embodiment illustrated in FIG. 3, there are performed an operation of removing a sheath of an electric cable 50 serving as a main cable, in an intermediate region thereof, to expose an inner conductor 52, and an operation of removing a sheath of an electric cable 50 serving as a branch cable, in one of opposite ends thereof, to expose an inner conductor 62, and thereafter the inner conductor 62 is connected to the inner conductor 52 by welding to form a spliced portion (branching connection portion). In this case, a water-sealing treatment can be efficiently performed by placing a water-sealing agent onto each of opposite ends of the sheath removal region in the electric cable 50 and the end of the electric cable 60 (a boundary portion between a region which has undergone the sheath removal and a region excluded from the sheath removal), and simultaneously pressurizing an ambient air around the water-sealing agent.

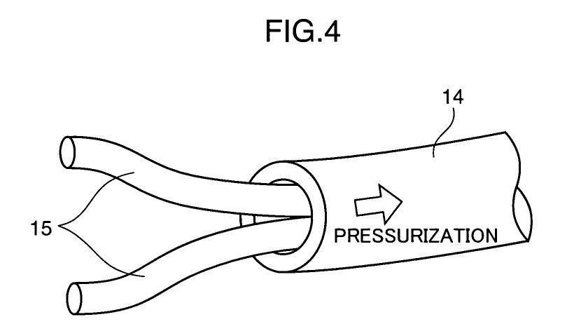

A target cable to be subjected to the treatment according to the present invention is not limited to the above insulated wires. As illustrated in FIG. 4 as a second embodiment of the present invention for example, the target cable includes an on-vehicle electric cable comprising one or more insulated wires 15 serving as the inner wire segment and a sheath 14 covering the outside of the insulated wires 15. This on-vehicle electric cable also can be subjected to an efficient water-sealing treatment in the same manner as that described above, by placing a water-sealing agent to cover a gap between the sheath 14 and each of the insulated wires 15, from the outside the sheath, and pressurizing an ambient air around the water-sealing agent.

### EXAMPLE 1

Based on the method illustrated in FIGS. 1 and 2, the water-sealing treatment was performed under the following conditions while appropriately changing an operating pressure.
Length of cable: 1 m
Sectional area of cable: 0.85 mm²
Water-sealing agent used: silicone rubber (viscosity: 0.6 Pa·s)
Amount of dropped water-sealing agent: 10 to 20 mg
Operating pressure (gauge pressure): the treatment was performed using the following three modes: a) pressurizing the target end 16 to 300 kPa; b) pressurizing the target end 16 to 200 kPa; c) depressurizing the other end on the opposite side of the target end 16 to −70 kPa (conventional method)

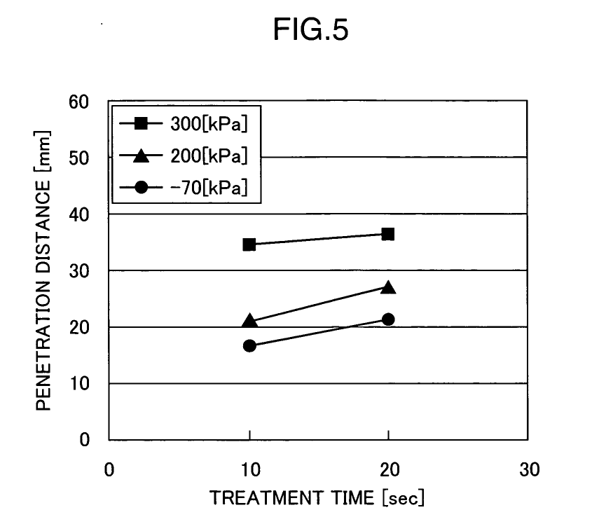

The results of this water-sealing treatment are shown in FIG. 5. In FIG. 5, the “Penetration Distance” means a maximum value of a distance from an edge position of the sheath 14 to the deepest position of the water-sealing agent penetration.

As shown in FIG. 5, the method designed to depressurize the other end on the opposite side of the target end 16 having the water-sealing agent supplied thereto to −70 kPa (absolute pressure: about 30 kPa) can achieve a resulting penetration distance only about 17 to 21 mm for a treatment time of 10 to 20 sec. In contrast, pressurizing the end with the supplied water-sealing agent to 200 kPa (absolute pressure: about 300 kPa) can achieve a resulting penetration distance about 21 to 28 mm for the same treatment time of 10 to 20 sec. Furthermore, pressurizing the end to 300 kPa (absolute pressure: about 40 kPa) can achieve a resulting penetration distance about 35 to 37 mm for the same treatment time.

These results would be obtained for the following major reason: The conventional method designed to depressurize the opposite end to −70 kPa can obtain only 70 kPa as a pressure difference serving as a moving force of the water-sealing agent, i.e., a difference between respective pressures of ambient air around the water-sealing agent and an air residing in the inside 9 of the sheath, whereas the method designed to pressurize the end having the water-sealing agent placed thereon as in the present invention can set the pressure difference at 100 kPa or more (in the Example, 200 kPa and 300 kPa).

1. A method for the water-sealing treatment of an on-vehicle electric cable which has an inner wire segment and a sheath covering said inner wire segment, comprising:
a water-sealing-agent placing step of establishing a state in which a gap between said inner wire segment and said sheath of said on-vehicle electric cable is covered by a water-sealing agent having fluidity, from the outside of said sheath; and
a pressurizing step of setting a pressure of an ambient air around said water-sealing agent covering said gap higher than a pressure of the inside of said sheath, to cause said water-sealing agent to penetrate into the inside of said sheath.

2. The method as defined in claim 1, wherein said on-vehicle electric cable includes a plurality of wires which serve as said inner wire segment, wherein said pressurizing step includes setting a pressure of an ambient air around said water-sealing agent placed in said water-sealing-agent placing step higher than a pressure of the inside of said sheath, to cause said water-sealing agent to penetrate into said gap between said inner wire segment and said sheath and further into gaps between said respective wires.

3. The method as defined in claim 1, wherein said on-vehicle electric cable is a grounding cable for grounding a circuit to be mounted on a vehicle, having at least one of opposite ends to which end a grounding terminal adapted to be connected to a specific region of said vehicle is attached, wherein said water-sealing-agent placing step and said pressurizing step are performed on said end for attachment of said grounding terminal.

4. The method as defined in claim 1, wherein said pressurizing step includes setting a difference between the respective pressures of the ambient air around said water-sealing agent and the inside of said sheath, at 1 atm or more.

5. The method as defined in claim 1, which includes a sheath removing step of, before said water-sealing-agent placing step and said pressurizing step, locally removing said sheath of said on-vehicle electric cable to expose said inner wire segment, wherein said water-sealing-agent placing step and said pressurizing step are performed on a boundary portion between a region which has undergone said sheath removal and the remaining region excluded from said sheath removal.

6. The method as defined in claim 5, which includes a terminal attaching step of removing said sheath in one of opposite ends of said on-vehicle electric cable, and attaching an electric cable terminal to said end, wherein said water-sealing-agent placing step and said pressurizing step are performed on said end having said electric cable terminal attached thereto, after said terminal attaching step.

7. The method as defined in claim 6, wherein said water-sealing-agent placing step includes dropping said water-sealing agent onto said end of said on-vehicle electric cable having said electric cable terminal attached thereto, in such a manner that said water-sealing agent covers a gap between said inner wire segment and said sheath in said end, from the outside of said sheath.

8. The method as defined in claim 6, wherein said pressurizing step includes supplying a compressed air into a pressurization container while containing said end of said on-vehicle electric cable having said electric cable terminal attached thereto, in said pressurization container, together with said electric cable terminal.

9. The method as defined in claim 5, wherein said sheath removing step includes locally removing said sheath in an intermediate region of said on-vehicle electric cable, wherein said water-sealing-agent placing step and said pressurizing step are performed on each of opposite ends of said region which has undergone said sheath removal.

10. An on-vehicle electric cable comprising an inner wire segment and a sheath covering said inner wire segment, wherein the inside of said sheath in at least one of opposite ends thereof is filled with a water-sealing agent by the method as defined in claim 1.
